(19) United States
(12) Patent Application Publication
(10) Pub. No.: US 2013/0262198 A1
(43) Pub. Date: Oct. 3, 2013

(54) SYSTEMS AND METHODS FOR AN INTELLIGENT CARDLESS LOYALTY SYSTEM

(71) Applicant: Alan L. Chung, San Francisco, CA (US)

(72) Inventor: Alan L. Chung, San Francisco, CA (US)

(21) Appl. No.: 13/800,601

(22) Filed: Mar. 13, 2013

Related U.S. Application Data
(60) Provisional application No. 61/617,454, filed on Mar. 29, 2012.

(51) Int. Cl. G06Q 30/02

(52) U.S. Cl. CPC G06Q 30/0226
USPC 705/14.1

(57) ABSTRACT

The present solution provides a low cost mobile loyalty service that gives meaningful rewards to members to increase their loyalty. The systems and methods of the present solution provides an intelligent and cardless loyalty customer relationship management (CRM) system. The present solution leverages the ubiquitous availability of network connections and mobile phones to offer an easy to use, low cost subscription service that is accessible to even the smallest retail merchants. A single sign up give members an easy way to participate in loyalty programs across all businesses in the present solution's network.

### RELATED APPLICATION

This application claims the benefit of and priority to U.S. Provisional Application No. 61/617,454, entitled “Systems and Methods For An Intelligent Cardless Loyalty System”, and filed on Mar. 29, 2012, which is incorporated herein by reference in its entirety for all purposes.

### FIELD

The present application is generally directed to systems and methods for providing an intelligent and cardless loyalty customer relationship management (CRM) system.

### BACKGROUND

Retaining existing customers is an important goal of any business. The question is how can a business increase the loyalty of their customers? Having a great product and superior service are obviously critical Innovative marketers figured out that they can also increase loyalty by rewarding their best customer for their loyalty, which in turn increases their loyalty.

Ever since the first loyalty program, the Green Stamps program, customer loyalty program has been an important tool for businesses trying to retain their customers. Today every major airline, hotel, car rental and grocery company has a loyalty program. Over the years, loyalty programs have become more sophisticated and powerful. Loyalty programs have proven to be extremely effective, and can be an important component of any successful marketing program.

However, modern loyalty programs are expensive and complex which limits their adoption to large corporations. Small to medium sized retail businesses are often prevented from offering loyalty programs because of their technical complexity, high cost, and customer adoption hurdles. Customers have to be willing to fill out a program application first. The data has to be entered into a computer system. A membership card has to be issued and sent. Finally the point of sale system has to be sophisticated enough to read the membership card and track a customer's purchases. These are just a few of the barriers that prevent small to medium sized companies from offering a loyalty program.

### SUMMARY

The present solution overcomes these barriers by providing a low cost mobile loyalty service that gives meaningful rewards to members to increase their loyalty. The systems and methods of the present solution provides an intelligent and cardless loyalty customer relationship management (CRM) system. The present solution leverages the ubiquitous availability of network connections and mobile phones to offer an easy to use, low cost subscription service that is accessible to even the smallest retail merchants. A single sign up give members an easy way to participate in loyalty programs across all businesses in the present solution's network.

Some embodiments of the systems and methods of the present solution may sometimes be referred to as Perka, Perka platform or service, and/or the Perka network. The present solution provides one or more of the following advantages or benefits:
Each business can tailor their loyalty program to suit their business goals unlike coalition loyalty programs.
Rewards are tied to actual transactions of authenticated visits, unlike other check-in services.
Multiple effective communication channels to communicate to customers with extensive targeting parameters.
Loyalty data gathered by the present solution provides insights into their business previously unavailable to them.
Merchants to do not have to purchase, distribute and manage the physical loyalty cards.

In another aspect, the present solution provides a seamless and easy check-in process referred to as the magic check-in. Magic check-in is a powerful feature that makes using the present solution super easy for customers. This check-in process takes advantage of GPS and Wifi capabilities of smart phones, such as the iPhone and Android phones, to automatically identify which customer have entered a merchant's store. This saves the customer the need and time to locate the store in a list of merchants and checking into that store. Magic check-in not only makes it easier for members or customer to use the system, but it also offer additional assurance the customer is actually at the store and thus is eligible to earn loyalty rewards.

In another aspect, the present solution uses a Sound Wave Communication (SWC) technique for two devices to communicate data locally. The SWC technique provides data via audio communications—data is transmitted via audio produced out the speaker of one device and received by the microphone of the other device. This technique provides short distance data communications like those provided by Bluetooth but has the benefits of not needing special transceiver circuits and pairing setup before communication can take place. The two devices can communicate using SWC in an ad hoc manor without pairing setup. Furthermore, the devices only need to have microphones and speakers, which is present in all smart phones. When a member walks into a merchant, the member can take their smart phone running a SWC based application and hold the smart phone next to the merchant device to check-in and receive coupons or other transaction data.

In some aspects, the present solution is directed to a system and method of automatically checking in at a merchant location. A server receives a wireless network identifier and a merchant location for a plurality of merchant locations and stores in a database the network identifier in association with the merchant location for each of the plurality of merchant locations. The server receives from a client device a location of the client device. The server determines one or more merchant locations of the plurality of merchant locations that are within a predetermined distance of the location of the client device and transmits to the client device the network identifiers associated with the one or more merchant locations within the predetermined distance of the location. The server receives from the client device a notification that the client device is located at a merchant location of the one or more merchant locations associated with the network identifiers. The client device determined the merchant location responsive to a global positioning satellite (GPS) signal of the client device and a relative strength of network signals of the client device associated with the network identifiers. Responsive to the notification, the server registers that the client device checked in at the merchant location identified in the notification. In some embodiments, the client device is one of a mobile phone, a laptop, and a tablet computer. In some embodiments, the server transmits a reward or coupon to the client device.

In some aspects, the present solution is directed to a system and method of automatically identifying a merchant location of a client device. An application executing on a client device transmits a first location of the client device to a server. The application receives from the server a plurality of network identifiers within a predetermined distance of the first location. Each of the plurality of network identifiers may be associated with a different merchant. The application ranks a signal strength of the client device to the plurality of network identifiers and determines at which merchant the client device is located based on the ranking of the signal strength of the plurality of network identifiers. Responsive to the determination, the application transmits to the server identification of the merchant.

In some embodiments, the client device or user of the client device is automatically checked out of the location when the client device leaves the merchant by detecting when the signal strength of the network identifier of the merchant is below a predetermined signal strength and responsive to the detection, sending a notification to the server. In some embodiments, the first location is determined with a GPS signal. The network identifiers may identify WIFI networks, such as by SSIDs and the application detects the strength of the WIFI signal. In some embodiments, determining at which merchant the client device is located is done by selecting the network identifier with the highest relative signal strength. In some embodiments, the application re-detects the signal strength of at least one nearby network to determine if the client device is still within a predetermined distance of the at least one nearby network.

In some aspects, the present solution is directed to a system and method of conducting a transaction with an audio-based communication. A mobile device of a customer detects, via a microphone, a carrier tone emitted by a device of a merchant. The mobile device of the customer and the device of the merchant establish an audio based communication session between the mobile device and the device of the merchant. The mobile device transmits to the device of the merchant, via a speaker of the mobile device, a first audio signal comprising data to conduct a transaction and receives from the device of the merchant, via a microphone of the mobile device, a second audio signal comprising transaction data.

In some embodiments, receiving the second audio signal further comprises receiving at least one of a coupon, a transaction receipt, a check-in confirmation or a reward. In some embodiments, the carrier tone comprises a predetermined frequency and volume. At least one of the frequency or volume of the carrier tone may be outside a range of human hearing. In some embodiments, transmitting the first audio signal further comprises transmitting a customer identification. In some embodiments, receiving the second audio signal further comprises receiving a merchant identifier. In some embodiments, the mobile device encrypts the data to conduct the transaction and decrypts the merchant transaction data. In some embodiments, the mobile device is placed within a predetermined proximity of the merchant device. In some embodiments, the microphone is automatically enabled responsive to detecting that the mobile device is within the predetermined proximity of the merchant device. In some embodiments, the second audio signal comprising transaction data from a transaction performed by the device of the merchant for the customer.

### BRIEF DESCRIPTION OF DRAWINGS

The foregoing and other objects, aspects, features, and advantages of the present invention will become more apparent and better understood by referring to the following description taken in conjunction with the accompanying drawings, in which:

FIG. 1A is a block diagram of an embodiment of a network environment for a client to access servers;

FIGS. 1B and 1C are block diagrams of embodiments of a computing device;

FIG. 2A is a block diagram of an embodiment of a system for providing an intelligent and cardless loyalty system;

FIG. 2B is a block diagram of an embodiment of a method for providing an intelligent and cardless loyalty system;

FIG. 2C are example pictorials of embodiments of a the user interfaces of the customer and merchant applications of an intelligent and cardless loyalty system;

FIG. 3A is a block diagram of an embodiment of a system for automated location based check in services to a merchant;

FIG. 3B is a flow diagram of an embodiment of a method for automated location based check in services to a merchant;

FIG. 4A is a block diagram of an embodiment of a system for audio based communications for executing a transaction with a merchant; and

FIG. 4B is a flow diagram of an embodiment of a method for audio based communications for executing a transaction with a merchant.

In the drawings, like reference numbers generally indicate identical, functionally similar, and/or structurally similar elements.

### DETAILED DESCRIPTION

For purposes of reading the description of the various embodiments below, the following enumeration of the sections of the specification and their respective contents may be helpful:
Section A describes a network and computing environment which may be useful for practicing embodiments described herein;
Section B describes embodiments of an intelligent and cardless loyalty system;
Section C describes embodiments of systems and methods for location based automated check in services to a merchant; and
Section D describes embodiments of systems and methods for audio based communications to execute a transaction with a merchant;

### A. Network and Computing Environment

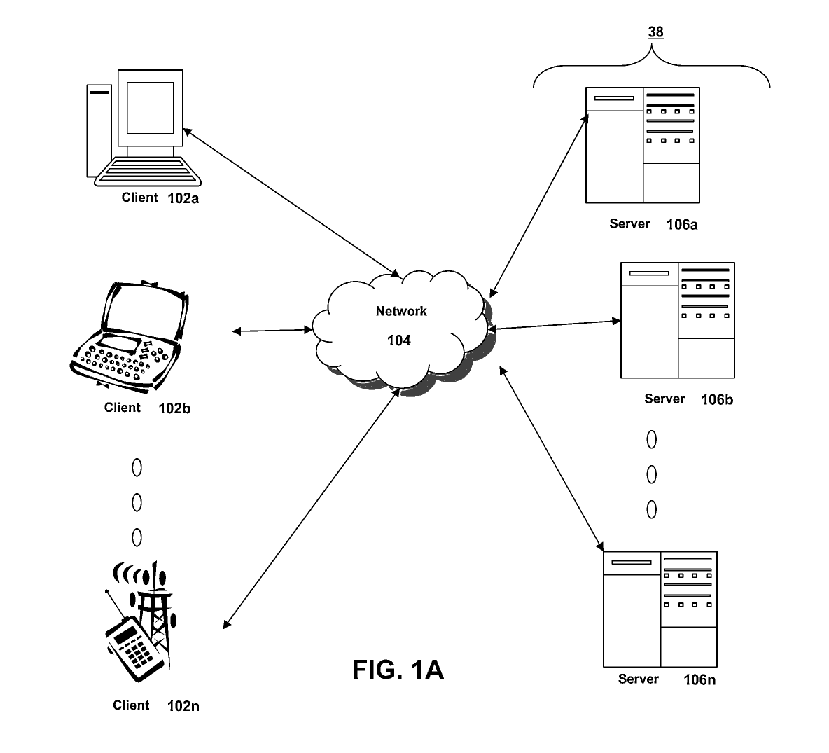

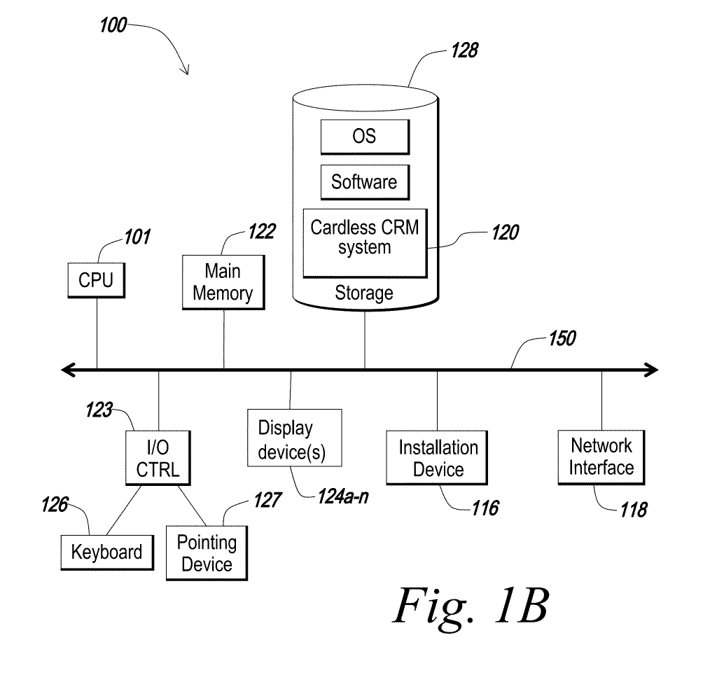

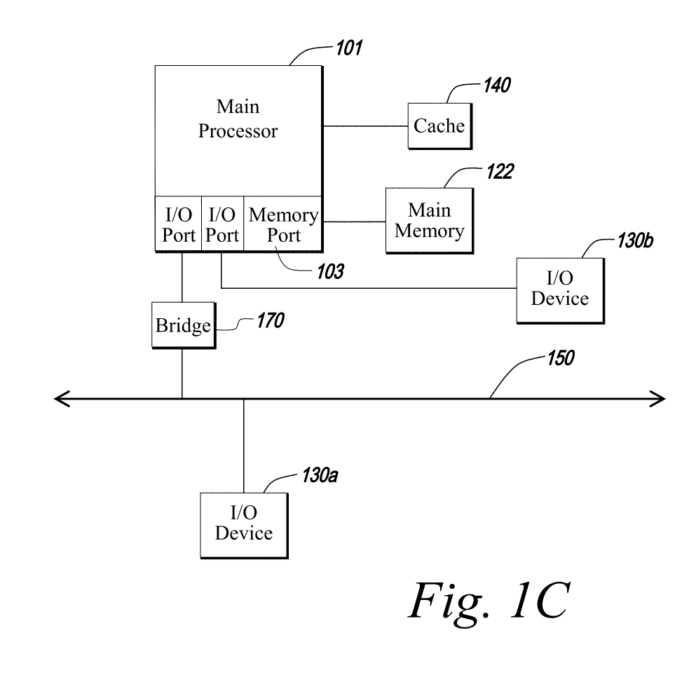

Prior to discussing the specifics of embodiments of the systems and methods of an appliance and/or client, it is helpful to discuss the network and computing environments in which such embodiments may be deployed. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix or Linux).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the VirtualServer or virtual PC hypervisors provided by Microsoft or others.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

The client 102 and server 106 may be deployed as and/or executed as any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-102n, a keyboard 126 and a pointing device 127, such as a mouse. The storage device 128 may include, without limitation, an operating system, software, and a software of intelligent and cardless loyalty CRM system 120. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, a flash memory drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the software 120 for intelligent and cardless loyalty CRM system. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, WINDOWS VISTA, and WINDOWS 7, all of which are manufactured by Microsoft Corporation of Redmond, Washington; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPOD, IPHONE, or APPLE TV family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED, NINTENDO REVOLUTION, or a NINTENDO WII device manufactured by Nintendo Co., Ltd., of Kyoto, Japan, an XBOX or XBOX 360 device manufactured by the Microsoft Corporation of Redmond, Wash.

In some embodiments, the computing device 100 may have different processors, operating systems, and input devices consistent with the device. For example, in one embodiment, the computing device 100 is a TREO 180, 270, 600, 650, 680, 700p, 700w, or 750 smart phone manufactured by Palm, Inc. In some of these embodiments, the TREO smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95c1, or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, and IPOD NANO lines of devices, manufactured by Apple Computer of Cupertino, Calif. In another of these embodiments, the digital audio player may function as both a portable media player and as a mass storage device. In other embodiments, the computing device 100 is a digital audio player such as the DigitalAudimpression opportunity layer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the Zen Vision W, the Zen Vision series, the Zen Portable Media Center devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the communications device 102 includes a combination of devices, such as a mobile phone combined with a digital audio player or portable media player. In one of these embodiments, the communications device 102 is a smartphone, for example, an iPhone manufactured by Apple Computer, or a Blackberry device, manufactured by Research In Motion Limited. In yet another embodiment, the communications device 102 is a laptop or desktop computer equipped with a web browser and a microphone and speaker system, such as a telephony headset. In these embodiments, the communications devices 102 are web-enabled and can receive and initiate phone calls. In other embodiments, the communications device 102 is a Motorola RAZR or Motorola ROKR line of combination digital audio players and mobile phones.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Intelligent and Cardless Loyalty CRM System

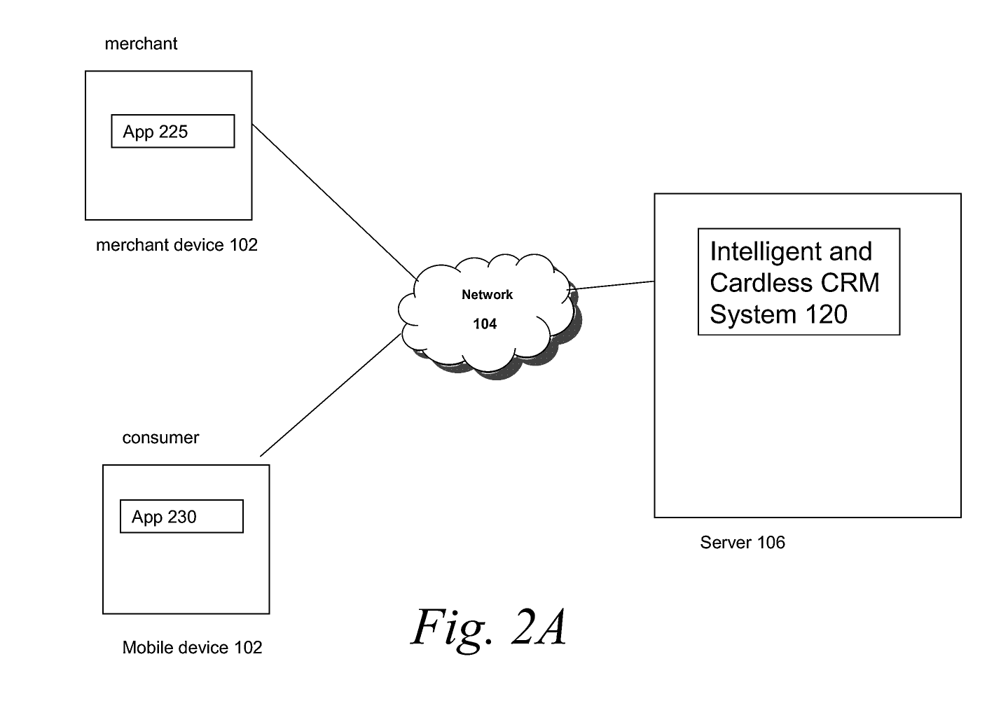

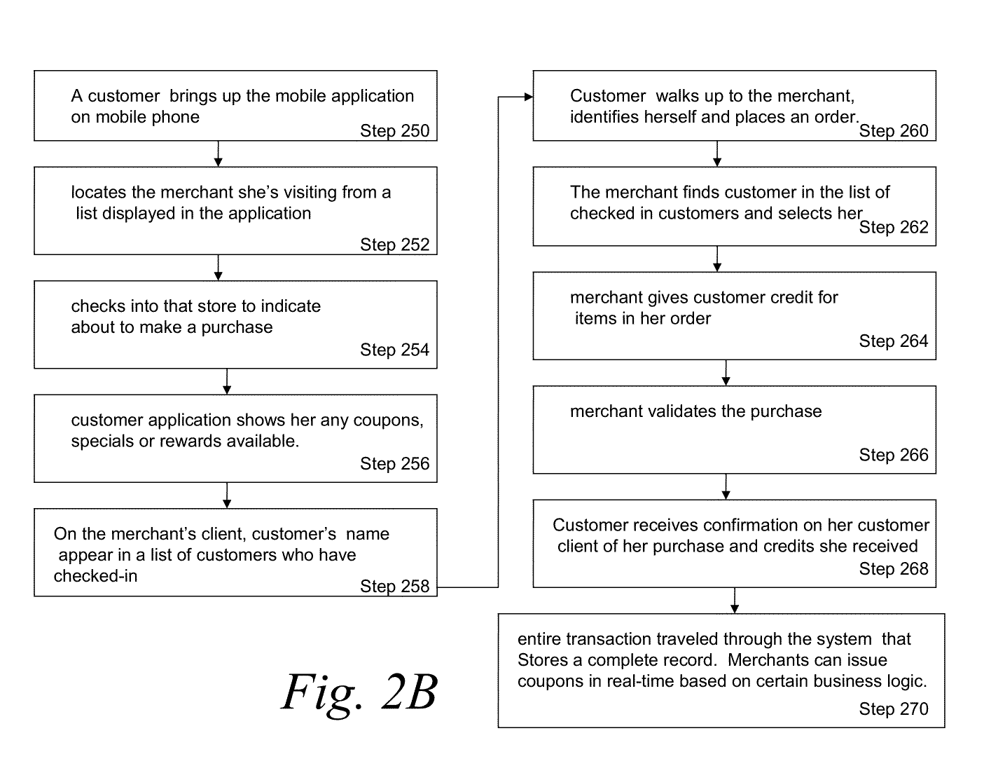

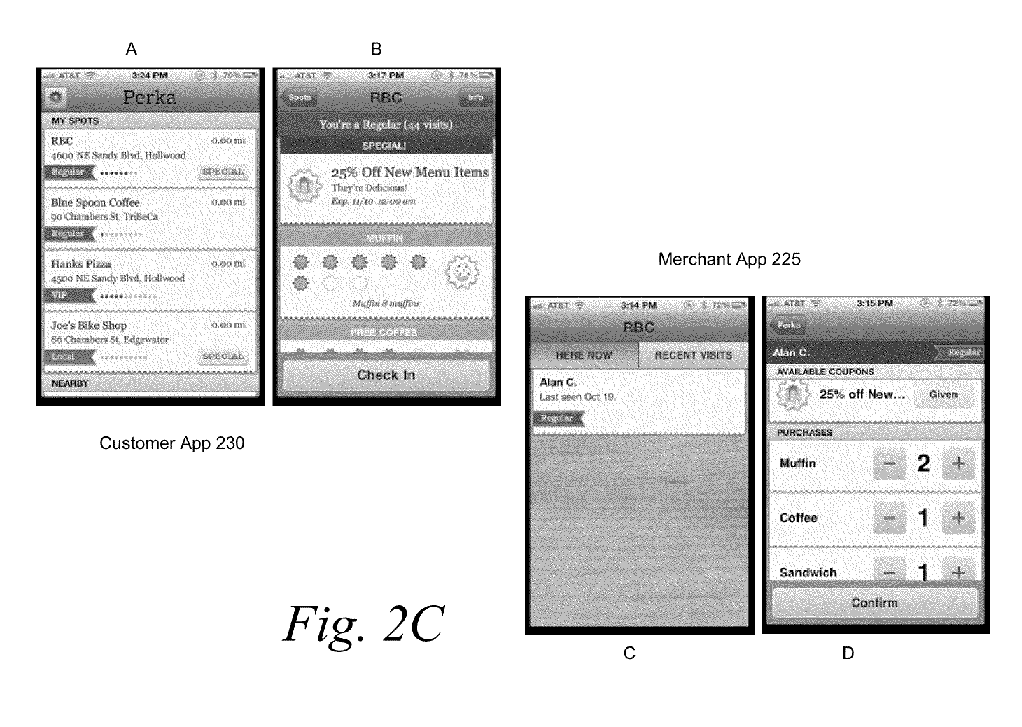

Referring now to FIGS. 2A and 2B, systems and methods of embodiments of the intelligent and cardless loyalty CRM system is depicted. The intelligent and cardless loyalty CRM system leverages the ubiquitous availability of network connections and mobile phones to offer an easy to use, low cost subscription service that is accessible to even the smallest retail merchants. The customer's may use an application on their mobile or smart phone that communicates or interfaces with the CRM system. Likewise, the merchant may have an application for a mobile device or computing device that communicates or interfaces with the CRM system Members can sign up for the service with a single sign on or account and participate in loyalty programs across all businesses in the CRM's network, all without using or carrying a merchant specific physical loyalty card.

Referring now to FIG. 2A, an embodiment of the intelligent and cardless loyalty CRM system is depicted. In brief overview, the system may include the CRM system 120 operating on one or more servers 106. A plurality of consumers may have a mobile device or client device 102, such as a smart phone, in communication with the CRM servers over one or more networks 104. The consumer's device may include a customer side CRM application or customer application 230 that communicates and interfaces with the CRM system 120. A plurality of merchants may have a mobile device or computing device 102 in communication with the CRM servers over one or more networks 104. The merchant's device may include a merchant side CRM application or merchant application 225 that communicates and interfaces with the CRM system 120.

The customer application 230 may comprise any type and form of executable instructions executing on a device, such as a mobile application referred to as an app that runs on mobile devices and smart phones. Customer applications can be implemented in many different ways on different operating platforms such as HTML, iOS, Android, Windows, or any other mobile software development platform. The customer application can be implemented using native development tools, cross platform tools or SMS.

The customer application 230 may be designed and constructed to provide customer side loyalty rewards program functionality. Although the customer application may work along side or in conjunction with a physical loyalty rewards card program or loyalty rewards based on a membership identifier, the customer application may be designed and constructed to allow the customer to use and access the loyalty rewards program for a merchant without a physical card or a loyalty rewards membership identifier. The customer application may comprise functionality, operations and/or user interfaces to establish an account with the CRM system 120 and/or to sign up for any merchant's loyalty program available via the CRM system.

The customer application may comprise functionality, operations and/or user interfaces to locate merchants in the CRM's network. The customer application may comprise functionality, operations and/or user interfaces to learn more about the merchant and/or the merchant's loyalty program offering. The customer application may comprise functionality, operations and/or user interfaces to check into a merchant's store, such as a store for which the customer has a loyalty membership via the CRM system. The customer application may comprise functionality, operations and/or user interfaces to inspect the current loyalty status level at each merchant the customer have visited. The customer application may comprise functionality, operations and/or user interfaces to inspect the rewarded earned. The customer application may comprise functionality, operations and/or user interfaces to inspect the progress towards a reward. The customer application may comprise functionality, operations and/or user interfaces to review or inspect any coupons or specials offered by a merchant. The customer application may comprise functionality, operations and/or user interfaces to share or forward any coupons or specials offered by a merchant. The customer application may comprise functionality, operations and/or user interfaces to redeem any coupons or specials offered by a merchant. The customer application may comprise functionality, operations and/or user interfaces to inspect any coupons or specials offered by a merchant provide service or other feedback to the merchant.

The merchant application 225 may comprise any type and form of executable instructions executing on a device, such as an app that runs on mobile devices and smart phones or a desktop application running on a desktop or laptop computing device. Merchant applications can be implemented in many different ways on different operating platforms such as HTML, iOS, Android, Windows, or any other mobile software development platform. The merchant application can be implemented using native development tools, cross platform tools or SMS. In some embodiments, the merchant application executes on a point of sale system or device of the merchant. In some embodiments, the merchant application interfaces to or is in communication with a point of sale system or device of the merchant.

The merchant application 225 may be designed and constructed to provide merchant side loyalty rewards program functionality. Although the merchant application may work along side or in conjunction with the merchant's physical loyalty rewards card program or loyalty rewards based on a membership identifier, the merchant application may be designed and constructed to allow the customer to use and access the loyalty rewards program of the merchant without a physical card or a loyalty rewards membership identifier. The merchant application may comprise functionality, operations and/or user interfaces to establish a merchant account with the CRM system 120 and/or establish and describe the merchant's loyalty program to be made available via the CRM system.

The merchant application may comprise functionality, operations and/or user interfaces to inspect a list of customer who have checked into the store. The merchant application may comprise functionality, operations and/or user interface to select one of the customer and inspect their purchase history, loyalty status, available rewards, etc. The merchant application may comprise functionality, operations and/or user interfaces to give purchase credit to a customer. The merchant application may comprise functionality, operations and/or user interfaces to redeem coupons, specials, or rewards. The merchant application may comprise functionality, operations and/or user interfaces to inspect the store's overall performance history. The merchant application may comprise functionality, operations and/or user interfaces to offer coupon, specials or rewards to customers.

The CRM system 120 may comprise an application, program, library, scripts, service, process, tasks or any type and form of executable instructions executing on one or more servers. The CRM system may comprise a plurality of functional modules or components that work together to provide any of the functionality and operations described herein. In some embodiments, the CRM system may comprise a web interface of a web application. The CRM system may communicate with customer applications and merchant application using any type and form of protocols and application programming interfaces.

The CRM may comprise functionality, operations and/or mechanisms to provide and perform security and authentication. The CRM system may comprise functionality, operations and/or user interfaces to provide or establish business logic that governs each merchant's loyalty program. In some embodiments, the CRM system provide an interface for the merchant to establish, manage or change the business logic for their loyalty program. The CRM system may comprise functionality, operations and/or user interfaces for sign up, billing and other administrative functions.

The CRM system may include and/or interface to one or more databases. The CRM system may store transaction information and data to the databases. The CRM system may stores to the database customer and merchant authentication information. The CRM system may provide an interface for a merchant, such as a web interface of via the merchant application, to access merchant related transaction data from the database. The CRM system may provide an interface for a customer, such as a web interface of via the merchant application, to access customer related transaction data from the database.

The combination of the customer application and merchant application with the CRM system provides a unique and powerful loyalty CRM system. Many loyalty systems have only a server and merchant side client and not any customer application. For example, loyalty programs from Safeway, CVS, Petco, etc. have a server, and merchant side client, but for consumers they've only a plastic card which doesn't provide any interaction or ability to communicate coupons.

Referring now to FIG. 2B, an embodiment of a method of using the intelligent and cardless loyalty system is depicted. In brief overview, a customer's transaction using a smartphone may have the following steps. At step 250, a customer launches the customer application 230 on her mobile phone. At step 252, the customer locates the merchant she's visiting from a list displayed in the application. At step 254, she checks into that store to indicate she's about to make a purchase. At step 256, the customer application shows her any coupons, specials or rewards available. The customer application may show her progress towards her next reward. At step 258, on the merchant's application 225, the customer's name appear in a list of customers who have checked-in. At step 260, the customer walks up to the merchant, identifies herself and places an order. At step 262, the merchant finds the customer by name in the list of checked in customers displayed by the merchant application 225 and selects her. At step 264, the merchant gives the customer credit for the items in her order. At step 266, the merchant validates the purchase. At step 268, the customer receives confirmation on her customer application/device of her purchase and credits she received. At step 270, the entire transaction has traveled through the system 120 which has stored a complete record of the transaction. Merchants can issue coupons in real-time based on certain business logic.

In further details, at step 250, a user launches the customer application on the user's mobile device by locating and launching the application in accordance with the operating system mechanisms for launching applications, such as via selection of a user interface element provided by the operating system to execute the application. In some embodiments, a user of the mobile device finds the application's icon on the application screen, then selects and clicks on the icon to launch the application. In some embodiments, the user goes to a web page of the CRM system via the user's mobile device and executes the application via the web page. The customer application may be acquired from an app stores, such as Itunes or Google Play, or downloaded from a server, such as the merchant's server or a server of the CRM application.

At step 252, the user may view a list of merchants via the customer application 230. For example, the customer application may display a list of Perka merchants responsive to launching the customer application. In some embodiments, the customer application may display a list of Perka merchants responsive to the user's request, such as via selection of a menu item or command of the customer application. The list can be sorted in different ways. For example, the list can be sorted alphabetically, by recent visits, or by distance. The customer locates the merchant she is about to visit or is currently visiting on that list and selects the merchant. In FIG. 2C, an embodiment of a user interface A of the customer application 230 illustrates a list of Perka merchants with information about the merchant and distance.

At step 254, the user (e.g., customer) may check into the store by selecting a check-in button, command or request via the customer application. The user may select the merchant via step 252 and at this step, select a check-in button to check into the selected merchant. In FIG. 2C, an embodiment of a user interface B of the customer application 230 illustrates a selected merchant and a check-in button for checking in to that merchant. In some embodiments, the user checks into the store by tapping the check-in button of the customer application. Checking in is the customer's way to indicate she is planning on visiting that store or merchant. In some embodiments, the customer may check in by using Near Field Communication (NFC). With NFC, for example, the customer can check in by bringing their NFC enabled mobile device near the merchant device 102. The mobile device communicates locally with the merchant device and provides/exchanges data to perform a check-in to the merchant.

Responsive to a check in request of the user or selecting check in on the customer application, the customer application may send a check-in message to the Perka server. The check in may include information about the user, merchant, check-in time, location, time, etc. The check-in message may identify the user or customer using the customer application and/or of the mobile device. The check-in message may identify the location of the user based on any GPS information provided by the mobile device. The check-in message may identify the merchant for which the user or customer is checking in. The check-in message may identify the time for which the user selected to check-in. The check-in message may provide any information available from the mobile device, such as type of device, manufacturer of device, operating system type and version of the device, software and applications of the device, cellular network service provider, wireless network id the device may be connected to if any, if Bluetooth is enabled or not, if the device has an NFC module or the NFC module is enabled or not, security information, such as type of encryption, etc. The check-in message may provide any information available via cookies or data stored for the CRM system and/or by the customer application.

Responsive to the check-in message, the server identifies that the customer is at the merchant's store. The server registers the customer is checked-in at the merchant. The server may look up a user profile of the customer stored on or accessible by the server. The server may look up a merchant profile of the merchant stored on or accessible by the server. From the merchant profile, the server may identify network information (such as IP address and port) to which to connect to or communicate with the merchant's merchant app. The Perka server 106 sends the customer's information to the merchant app 225 at the location as which the customer is checked in at. The merchant app receives and processes the customer information and may display the new customer in a checked-in list.

At step 256, the customer application 230 may display to the user any information about the merchant and any special, deals or rewards available at the merchant. The customer application may display the user's consumption of specials, deals or rewards, such as via a history. In some embodiments, the customer application displays the electronic punch cards available at that merchant. For example, a coffee shop might have 2 programs: Buy 10 coffees get 1 free, and Buy 8 muffins get 1 free. For example, in FIG. 2C, the user interface B of the customer application illustrates such an electronic punch card. In some embodiments, the customer application displays the user's consumption or use of the electronic punch cards at that merchant. For example, the customer's card will show how much coffees and muffins they've purchased. If they've earned a free coffee or muffin, those rewards are also displayed here. In some embodiments, the customer application displays a facsimile of a punch card with the number of punches visually indicated, such as via graphics. The customer application may display any coupons and specials that are available to the customer. The merchant via the Perka system may display to the user via the customer application any promotions, specials or rewards personalized or specialized for that user.

In further detail, an electronic punch card may comprise a digital or electronic form of a paper based coupon or punch card. The electronic punch card may be represented by a data structure or object that can be stored in a database and processed electronically by the customer app, merchant app and/or Perka server. The electronic punch card may be visually represented by any type and form of user interface elements and/or widgets to have an appearance of a coupon or punch card.

At step 258, the merchant application 225 may list the customers who have checked into the store or who are currently checked in. The merchant application may list the customers in sorted order, such as by time of check-in. The merchant application may identify those customers who are new customers, those customer who are returning customers and/or those customers who are preferred type of customers or customers having a predetermined status with the merchant. The merchant application may list the name of the customer and any customer information provided about the customer from the Perka system, such as a user profile. In some embodiments, the merchant application shows a picture of the customer if the customer has added a photo to their Perka profile. A picture may help make it easier for the merchant to locate a customer in the list at the store. The merchant application may provide or display a transaction history of the customer. The merchant application may provide or display the customer's use of coupons, promotions, specials or rewards at the merchant. The merchant application may provide or display the customer's electronic punch cards for the merchant, such as those electronic punch cards that are active or still useable or otherwise in use. In FIG. 2C, an embodiment of a user interface C of the merchant application 225 illustrates a list of customers who checked into the merchant.

At step 260, the customer enters a merchant's store and identifies herself and places her order. For example, in a coffee shop, she introduces herself when she walks up to the barista to place her order, “My name is Julie and I'm a Perka user”. In a sit down restaurant, the user might identify themselves as a Perka user when the bill arrives. In some embodiments, the customer may place an order via the customer application, which may send the order directly to the merchant application or may sent the order via the Perka servers to the merchant application. In some embodiments, the customer may place an order using an electronic ordering system of the merchant. In some embodiments, the customer may place an order by communicating with an order taker, waiter, waitress or server of the merchant.

At step 262, the merchant looks for the customer in the list of checked-in customers of the merchant app and selects the customer. For example, a worker of the merchant may identify the customer by name and/or face in the list of checked-in customers and select the identified customer list. Upon selection, the customer may be the current customer to be processed by the merchant app and/or to provide context for functions via the merchant app. In some embodiments, selection of the customer can happen automatically with NFC. For example, the customer may place their NFC based mobile device near the NFC device of the merchant's device. The customer's mobile device may transmit data identifying the customer to the merchant. The merchant application may receive information identifying the customer and select the customer from the list of checked-in customers.

The merchant, such as via the merchant worker, may receive the customer's order. The merchant may enter the customer's order via the merchant's point of sale system. The merchant may total the amount of the order and receive and process payment via cash, credit, debit or another other accepted form of currency.

At step 264, based on the purchase of the customer the merchant gives credit via the merchant app to the items the customer ordered. For example, in a coffee shop a customer might order a coffee, a muffin and an orange juice. This store may offer a loyalty program for coffee and muffin but not orange juice so the merchant gives her credit in the Perka merchant app 225 for the coffee and muffin. In some embodiments, the merchant may use an interface of the merchant app to enter or select the items for which credit is being given. In some embodiments, the merchant may virtually punch the customer's electronic punch card via the merchant app or otherwise identify an item and/or quantity for which the customer is getting credit under their loyalty or reward program. In some embodiments, the credit on the merchant's app may occur automatically from the merchant's point of sale system. The merchant app may integrate, interface to and/or communicate with the POS system to receive the order of the customer and automatically process corresponding credit within the merchant application.

At step 266, the merchant may review and validate the credit to be granted to the customer under the loyalty or rewards program or for otherwise punching the customer's electronic punch card. The merchant app may allow the merchant or user thereof to make corrections, edits or additions to the credit. In FIG. 2C, an embodiment of a user interface D of the merchant application 225 illustrates a user interface for reviewing and correcting the credit. The merchant may validate the credit by selecting a validate button or user interface element to commit the credit to the customer. Upon selection of the validate button, the merchant apps sends the information about the credit for the customer to the Perka server 106. The merchant app may send any information about the customer, the purchase of the customer, and/or the credit to be given the customer. The merchant app may send to the Perka server temporal information on the credit transaction, such as date and time. The merchant app may send to the Perka server item description and quantity information of the credit transaction. The merchant app may send to the Perka server any information about the order, such as items not credited to the merchant's loyalty or rewards program, received from the merchant's POS system.

The merchant app may automatically check-out the customer upon completion of the transaction. In some embodiments, the merchant app checks-out the customer upon selecting validation of the credit. In some embodiments, the merchant app checks-out the customer upon receiving confirmation from the Perka server that the transaction has been recorded. In some embodiments, the merchant selects a check-out button from the merchant app to check-out the customer. In some embodiments, the check-out function is incorporated or is part of the validate button.

At step 268, the Perka server receives transaction information from the merchant app and processes and records the transaction and any corresponding information. The Perka server may send the transaction information to the customer's app 230. The customer app 230 may update the display with any new punches earned, rewards redeemed, and coupons used. The customer can double check whether the transaction is correct and can let the merchant know if she think there's an error. Otherwise, the customer may perform another transaction or may leave the merchant's store or location.

At step 270, the Perka server has tracked and stored the entire transaction initiated from a customer checking in at a merchant's store to the completion of a customer's transaction with the merchant. Via the customer app and the merchant app, events and information about the transaction are communicated to and through the Perka server. With this data stored at the Perka server for a customer, the Perka server maintains data that can be used for analytics. Based on the analytics, merchants can use the data for campaigns to their customers and/or for designing future coupons or rewards. In some embodiments, the merchant can select the customer and track the customer's purchases, give rewards after certain amount purchased, send out coupons or special to the customer depending on merchant desired or specified business logic.

In some embodiments, the customer can check-in using SMS. Each merchant store may have or be assigned a unique code word for SMS check-in. Customers can text the code word to Perka and the customer's name will show up in the merchant's list of checked-in customers as described above. The rest of the transaction may be the same as above. The ability to participate in any Perka loyalty program via SMS may be incredibly powerful as over 50% of mobile phone users have not upgraded to a smartphone.

The merchant has now captured purchase history associated with many individual customers. Previously this was not possible because the merchant doesn't have an easy way to identify individual customers. Now the merchant can easily see who are their best customers, how often they come to the store, how much they purchase, etc. To complete the CRM system, Perka provides a communication channel for merchant to reach their customer. Previously it was nearly impossible for small retail merchants to reach their customers via email, text or phone calls because they don't have their customer's contact info.

With Perka, merchant can communicate with their customers by offering coupons or specials, which are displayed in the Perka client. Perka provides a relevant and welcomed way for merchants to communicate with customers. It is also cost effective because they don't have to pay an email marketing service, or pay staff to make phone calls. Example, a merchant can identify previously loyal customers who have not visited the store in a while and sent them a special coupon to entice them to return. Perhaps that customer have switch to another store, by giving them a coupon they might return to being a loyal customer. “Bounce back” coupons are also very popular in retail business. The goal of a Bounce back coupon is to get a customer to come back to the store within a certain time period, it might be as short as a few days or a week. Studies have shown when a customer returns a few times to a store within a certain time period it helps the customer form a habit, it helps that store become a regular spot for the customer. Perka can make offering that “bounce back” coupon easy and cost effective.

Setting up an account is often a barrier for customers to try using an application for the first time. So if a customer can use a service without first creating an account that's very attractive. The main problem that the present solution overcomes is how to uniquely identify a customer if there is no login and password. Perka may use 2 pieces of data to identify customers. If the user is using the Perka application on a mobile phone, the application can obtain the device's unique device ID (UDID). If the user is using SMS to access Perka, the user's phone number is attached to the SMS so the phone number can be used. Together they allow Perka to uniquely identify a customer without requiring her to create an account. There is value for both the customer and Perka to have an account eventually, but making have an account optional before a customer can start using Perka is a great benefit to the user, the merchants and the operator/provider of the Perka system.

In view of the above systems and methods, the customer may check in with these pieces of information (UDID and/or phone number) to the Perka server, which may create a temporary or an initial account on the system. The Perka server may send the UDID and/or phone number to the merchant application for identifying a checked-in customer. The merchant application may give credit and transaction the check-out with the Perka server using this information to identify the customer. The Perka server may later associate this UDID and/or phone number, or any associated temporary account, with the customer once the customer establishes an account and profile on the Perka server.

### C. Systems and Methods For Automated Location Based Check-in

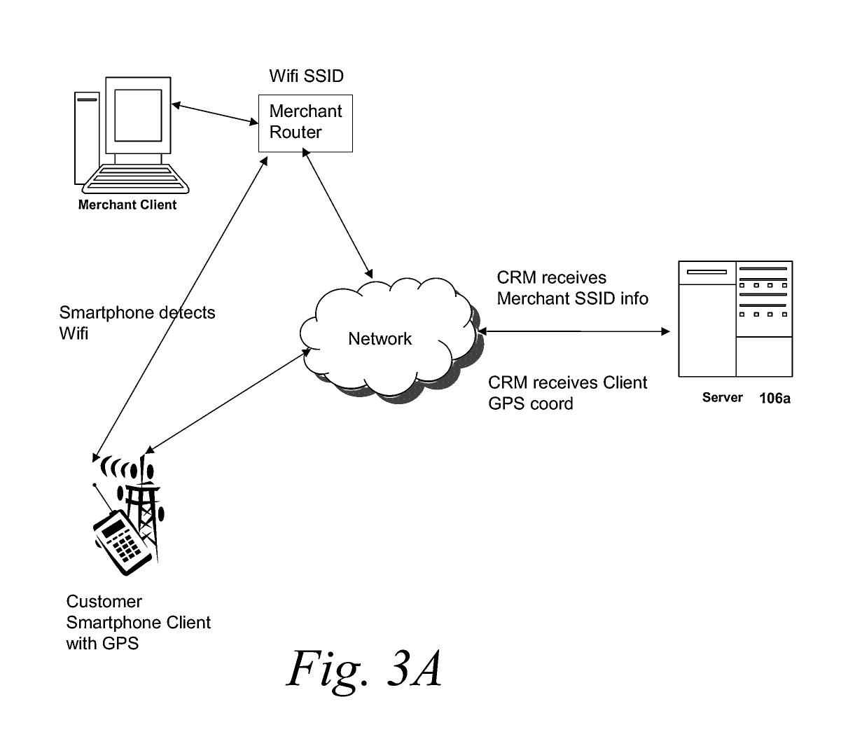

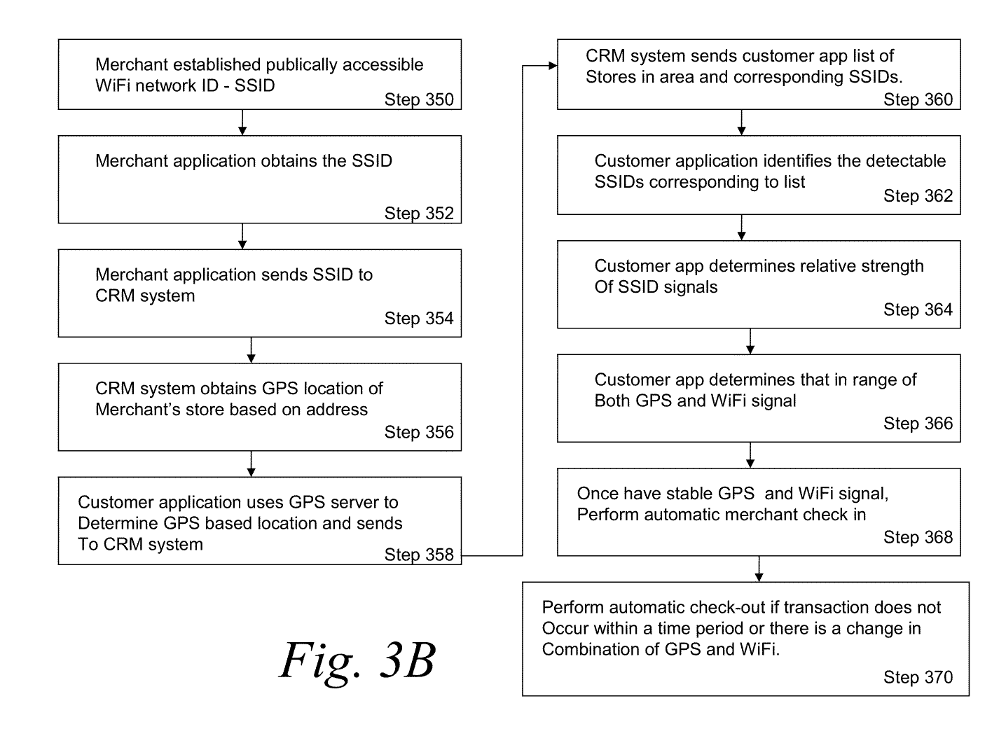

Referring to FIGS. 3A and 3B, systems and methods for a seamless and easy check-in process, referred to as a “magic check-in: is depicted. Magic check-in is a technique to simplify the CRM system interaction for customers. Specifically, magic check-in eliminates the need for steps 252 and 254 described above in connection with FIG. 2B. Customer applications with the Magic Check-in feature no longer require the customer to find the store they are visiting in a list and then check-in. The Magic check-in features handles these steps automatically using a combination of GPS and Wifi signal(s) to determine with great or a predetermined certainty a customer has entered a store or is otherwise visiting the merchant's premises.

Referring now to FIG. 3A, an embodiment of a system for the magic check-in technique is depicted. In brief overview, the system may include embodiment of the CRM system 120, the merchant application 325 and the customer application 330 that each support or have functionality to provide the location based check-in feature referred to as magic check-in. The merchant's application identifies the Wifi network ID or SSID and communicates this information to the CRM system. A customer with the customer application approaches a merchant's store. The customer's device has GPS signaling which identifies to the device and the CRM system a location of the customer within a predetermined distances, such as X feet of signal. The customer's device identifies the signal strength of detectable Wifi signals. Based on the GPS information and the WiFi SSID of the signal with the best strength, the system can identify the merchant corresponding to the SSID and perform the automatic check-in of the customer with the merchant.

The merchant application is designed and constructed to identify and track the Wifi router SSID used by the merchant device to access the Internet and to update the Perka server with the merchant's SSID. In some embodiments, the merchant application automatically obtained and identifies that information from the operating system of the merchant device. In some embodiments, a user of the merchant application identifies or specifies the SSID used by the merchant. For example, the merchant application may display a list of detectable SSID in range of the merchant device/application and a user selects a SSID from the list. The merchant application sends the SSID used at that merchant to the Perka server. Responsive to any changes to the SSID, the merchant application may update the Perka server with the latest or current SSID used by the merchant.

The customer application is designed and constructed to use two signals to pinpoint the location of the customer in a highly accurate way or otherwise in a way that has a predetermined level of accuracy. The two signals used are a GPS signal and a Wifi signal. The customer application is designed and constructed to automatically access and obtain GPS and WiFi signal device as provided by the mobile device, such as accessed via the operating system of the mobile device. The customer application may first use the GPS signal to locate the customer's general location. The customer application queries the Perka server for a list of merchants in that general area or within a predetermined proximity of the GPS signal. The customer application receives SSIDs of these merchants. The customer application uses the Wifi receiver in the mobile device to monitor all the visible Wifi signals and their corresponding signal strength. Those signals are matched against the SSIDs of merchants in the area. When there is a match that means the customer's mobile device's GPS and Wifi receiver are both indicating that the mobile device is within range of that merchant. The customer application can increase the certainty by tracking the Wifi signal strength. The customer application can determine that the Wifi signal is within a predetermined signal strength threshold and/or is maintained within the predetermined signal strength threshold. For example, the Wifi signal strength should be very strong when the customer is inside the store when compared to just walking by the store outside.

The CRM system is designed and constructed to track the SSIDs of each merchant. The CRM system may provide a user interface, such as a web interface, for a merchant to login and specify and/or update their SSID. The CRM system may provide a programmatic interface for a merchant to specify and/or update their SSID via the merchant application or other application. The CRM system may provide a programmatic interface for an application, such as the customer application, to perform queries for SSIDs of merchants. In some embodiments, a customer application may query a SSID of a merchant based on the name, type or location of a merchant. In some embodiments, a customer application may query available SSIDs based on GPS location, zip code, street, or other geographic location.

Referring now to FIG. 3B, an embodiment of a method for the magic check-in technique is depicted. In brief overview, the method at step 350, the merchant establishes a publically visible SSID. At step 352, the merchant application obtains the SSID and at step 354, the merchant application sends the SSID to the CRM system. At step 356, the CRM system obtains or determines GPS information for the merchant based on the merchant's address. At step 358, the customer application determines a GPS location of the customer's device and sends to the CRM system. At step 360, the CRM system sends to the customer application a list of merchants and SSIDs based on the GPS location. At step 362, the customer application identifies which SSIDs are detectable by the customer's device. At step 364, the customer application determines the relative strength of detectable WiFi signals of each SSID. At step 366, the customer application determines the customer device and thus the customer are in range of both GPS and WiFi signals. At step 368, the customer application determines the combination of GPS and WiFi signals are stable (e.g., for a predetermined time) and performs automatic check-in with merchant. At step 370, the customer application and/or merchant application may perform automatic check out based on change in signals or a timeout period for which a transaction does not occur.

In further details, at step 350, the merchant provides Wifi access at the store, either for private use or for public customer use. To make Magic Check-in available for the merchant's store, the merchant makes their WiFi's SSID publicly visible. The merchant may still protect WiFi access with a password so that store access is for private use. The merchant may have computing devices in the store, including the device running the merchant application and/or the POS system using this WiFi for Internet access.

At step 352, the merchant device may be connected to the Internet using Wifi. The merchant application may identify the merchant's Wifi SSID through the operating system. For example, the merchant application may make API calls to the operating system to return the WiFi SSID to which the device is connected or using. In some embodiments, the merchant application receives or identifies the merchant's Wifi SSID via a user interface in which a user specifies or selects the WiFi SSID.

At step 354, the merchant's SSID is sent to the Perka server. In some embodiments, the merchant application sends the merchant's WiFi SSID to the Perka server. In some embodiments, a merchant logins to the Perka server and updates the merchant's profile with the merchant's WiFi SSID. The merchant application may send the SSID at regular intervals. In some embodiments, the merchant application automatically sends an update of the SSID to the Perka server responsive to detecting changes to the merchant's SSID. The Perka server or CRM system executing thereon attaches, associates or otherwise updates the merchant's profile with the merchant's SSID.

The CRM system, such as a server, may receive a wireless network identifier and a merchant location from a plurality of merchant locations and store in a database the network identifier in association with the merchant location for each of the plurality of merchant locations. As such, the CRM system may have a database of or profiles of a multitude of different merchants, their location and one or more network identifiers, such as WiFi SSIDS of each merchant.

At step 356, the Perka server and/or CRM system obtains or determines GPS information for the merchant based on the merchant's address. The CRM system may perform a lookup or query of GPS information from any GPS based database or web-service. The CRM system may identify a single GPS point that identifies the merchant. The CRM system may identify a range of GPS data that identifies the merchant within a predetermined radius, block or location. The CRM system may identify a single GPS point that identifies the merchant. The Perka server and/or CRM system may store the merchant's GPS data in association with the merchant's SSID, such in the merchant's profile.

At step 358, the customer application uses the GPS module or feature in the customer's mobile device to determine the customer's location. The customer application may send this GPS information to the Perka server and/or CRM system. The customer application may send a request to the Perka server and/or CRM system to query merchant SSIDs based on GPS information of the customer's location. The customer application may send this request responsive to a user requesting to search for nearby merchants. The customer application may send this request automatically, transparently and seamlessly without user interaction.

At step 360, responsive to receipt of the GPS information or query of step 358, the Perka server and/or CRM system searches or queries the merchant database to determine a list of merchants in the area of the location identified by the GPS information. The merchant database may have coordinates of the merchant or corresponding GPS information of each merchant. In some embodiments, the Perka server and/or CRM system can query the merchant's coordinates via map or coordinate database or service. The Perka server and/or CRM system may search for merchants within a predetermined proximity, distance or radius of the GPS location. The Perka server and/or CRM system may search for merchants on the same block or street as the GPS information. The Perka server and/or CRM system may search for merchants in the same city as the GPS information. The Perka server and/or CRM system may send a response back to the customer application which includes a list of one or more merchant's and their corresponding network identifier, such as SSID.

At step 362, the customer application may identify or determine a list of one or more Wifi signals detectable by the customer's mobile device. In some embodiments, the customer application accesses the mobile device's Wifi receiver through the devices operating system. The customer application may make an API call to get list of all the visible Wifi signals and their corresponding. The customer application may identify the SSID of each of these detected or visible signals.

At step 364, the customer application may identify or determine the relative strength or strength of each of the detected WiFi signals. The customer application may filter out WiFi signals that do not meet a predetermined signal threshold. The customer application may filter out WiFi signals that are of a certain type.

At step 366, the customer application can match the detected SSIDs with the merchant's SSIDs received from the Perka server using the GPS information. With the SSIDs and their corresponding Wifi signal strength, the application can determine with high degree of accuracy if the customer device is inside the merchant's store versus the customer just walking past the store outside. Because Wifi signals have a limited range, the customer client can use both the GPS and Wifi information to determine with high degree of accuracy if a customer has entered a store (e.g., within a few hundred feet of the store's GPS location, and detecting a strong signal from the Wifi SSID signal. Wifi signals typically have a small range of a few hundred feet, less with walls and other obstructions.

The customer application may make this determination based on the strength of the signal as well as the change of the signal strength over time. For example, if the detected Wifi signal strength doesn't change dramatically for a period of time (15-20 seconds is typically enough time) the customer application can determine or conclude that the customer is at the store rather than walking or driving by the store. If they're just walking by the store, the customer application may detect that the Wifi signal has changed and/or changed pretty quickly. The customer application may be designed and constructed to monitor and detect a rate of change in the relative strength of detected or visible WiFi signals.

At step 368, the customer application determines that there is a stable signal from Wifi and GPS. The customer application may determine that each of the WiFi signals and GPS signals are maintained within a predetermined relative threshold for a predetermined time period. Based on the stability of the signal, the customer application determines that the customer is very likely in a Perka merchant's store. Responsive to this determination the customer application can automatically check in the customer into the merchant. In some embodiments, the mobile device determines the merchant location responsive to a global positioning satellite (GPS) signal of the client device and a relative strength of network signals of the client device associated with the network identifiers and sends a notification to server of the CRM system. Responsive to the determination, the customer application may send a check-in message to the Perka server as described above. This automatic check-in may occur without any user interaction and/or seamlessly and transparently to the user. The customer application may provide an indication to the user via the user interface of the customer application that the customer has been checked in.

The CRM system may receive from the mobile device the notification that the client device is located at a merchant location of the one or more merchant locations associated with the network identifiers. Responsive to the notification, the CRM system registers that the customer of the mobile device or otherwise the mobile device checked in at the merchant location identified in the notification. Response to the check-in or notification, the CRM system may send any communication, such as a coupon, reward, promotion or advertisement to the customer application for presenting to the user of the mobile device.

At step 370, if merchant validation does not happen before the customer application detects the customer has left both the GPS and Wifi area of the store, the customer application can automatically check-out the customer from the store. Perhaps the customer walked into the store to shop, but did not make a purchase before leaving. The customer application may monitor the stability of the each of the WiFi signals and GPS signals and determine when one or both of these signals fall out of range with respect to their respective thresholds. The customer application may determine that the customer has left the store when one or both of these signals fall out of range with respect to their respective thresholds for at least a predetermined length of time. In embodiments, the CRM system and/or customer application may automatically check customer and/or mobile device out of the location when the mobile device leaves the merchant by detecting when the signal strength of the network identifier of the merchant is below a predetermined signal strength and responsive to the detection, sending a notification to the server.

The following is an example embodiment of steps of the magic check-in method:
1. Magic check-in may leverage that the merchant has Wifi service with a publically visible SSID at the store, and the Perka merchant client is accessing the Internet via that Wifi connection. (The Wifi network can be protected and not accessible by the public, only the SSID has to be visible)
2. The merchant client obtains the Wifi network SSID from the operating system
3. The merchant client sends the Wifi SSID to Perka server
4. The Perka server also has the GPS location of the store based on the store's address
5. When a Customer client is running on a smartphone, it uses the phone's GPS to determine its location.
6. The Customer client sends the location information to Perka server, which replies by sending it a list of stores in the area and each store's Wifi SSID
7. The Customer client accesses the smartphone's operating system to identify the list of

SSID it can detect and the relative strength of each signal.
8. Because Wifi signals have a limited range, the customer client can use both the GPS and Wifi information to determine with high degree of accuracy if a customer has entered a store (i.e. Within a few hundred feet of the store's GPS location, and detecting a strong signal from the Wifi SSID signal. Wifi signals typically have a small range of a few hundred feet, less with walls and other obstructions.)
9. If the customer client has determined it is within range of both signals, and the Wifi signal strength doesn't change dramatically for a period of time (15-20 seconds is typically enough time) the customer client can conclude the customer is at the store rather than walking or driving by the store. If they're just walking by the store, the Wifi signal will change pretty quickly.
10. Once we've a stable signal from Wifi and GPS, the customer client can automatically check the customer in at that store. Now the rest of the transaction can proceed as normal and previously described herein.
11. If merchant validation does not happen before the customer client detects it has left both the GPS and Wifi area of the store, the customer client can automatically check-out the customer from the store. Perhaps the customer walked into the store to shop, but did not make a purchase before leaving.

### D. Systems and Methods For Audio Based Transactions

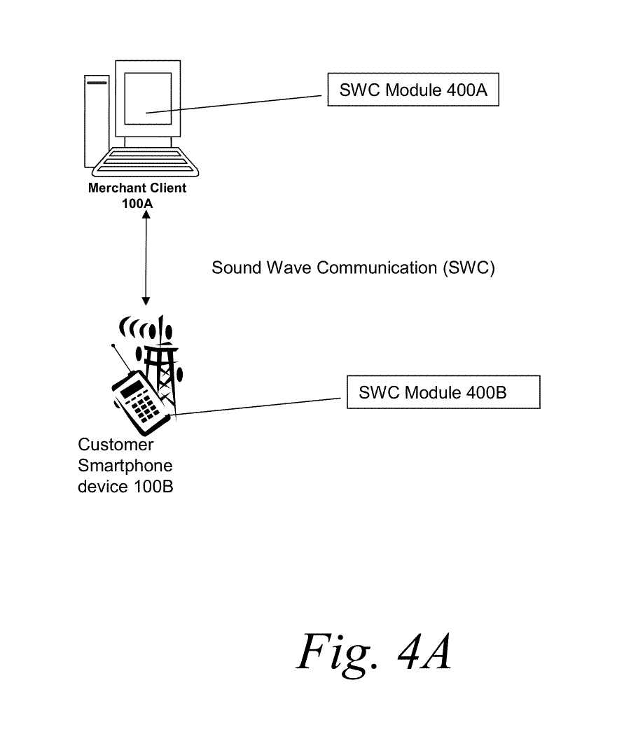

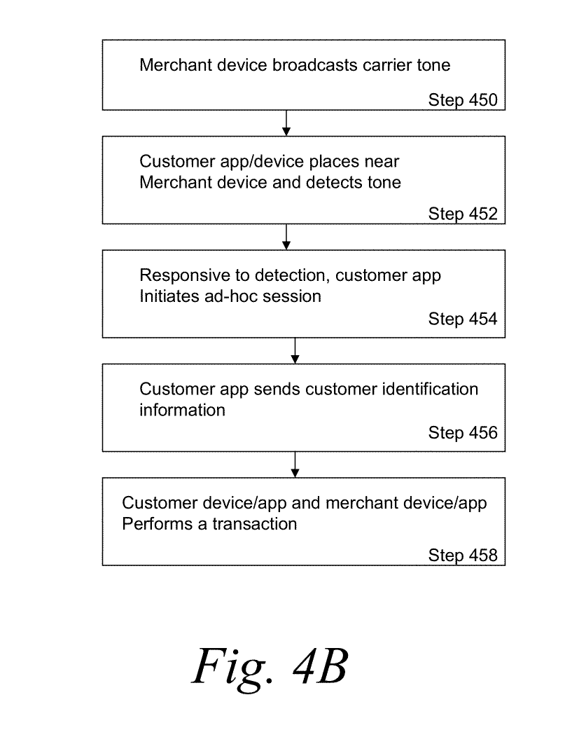

Referring to FIGS. 4A and 4B, systems and methods for using audio based communications to send data and perform transactions between a customer device and merchant device is depicted. These systems and methods used what is referred to as a Sound Wave Communication (SWC) technique for two devices to communicate data locally. The SWC technique is a local or proximity based transmission of data like Bluetooth but SWC has the benefits of not needing special transceiver circuits and pairing setup before communication can take place. The two devices can communicate using SWC in an ad hoc manner without pairing setup and the device only need to have microphones and speakers, which is present in all smart phones. When a CRM account member walks into a merchant, the member can take their smart phone running the customer application and hold the smart phone next to the merchant device to check-in and receive coupons or other transaction data.

Referring now to FIG. 4A, an embodiment of a system for using the SWC technique is depicted. In brief overview, the system may comprise two or more devices. Each of these device may include a speaker and microphone connected to a programmable compute platform, such as device 102 with a processor that may be programmed with executable instructions to perform the functionality and/or operation described herein. For example, one device may be a merchant client device located at the merchant site. This merchant client device may be any type and form of device 102 which may include a speaker and microphone. Another device may be a customer's mobile device which may include a speaker and microphone. Each of these device may comprise a SWC module 400A/400B (generally referred to a SWC module 400) for performing audio based communications and transactions between the two devices. The SWC module may be incorporated in or be part of the merchant app 225 and/or customer app 230.

The SWC module 400 may comprise hardware, software or any combination of hardware and software. The SWC module may include an application, program, script, library, task, process or any type and form of executable instructions executing on a device. The SWC module may include any logic, operations or functions to perform any of the SWC techniques described herein. The SWC module may be designed and constructed to perform any type and form of encoding and/or corresponding decoding scheme. The SWC module may be designed and constructed to operate at a predetermined range of audible or sound frequency. The SWC module may be designed and constructed to operate at a predetermined low frequency that provides a predetermined proximity range of two devices to be a certain distance to listen and send data using the SWC technique.

The SWC module may use any type and form of protocols for establishing session and/or transmitting data via the SWC technique. The protocol may be a transport or session layer protocol. In some embodiments, the SWC module may use a transport protocol to establish a transport layer or connection between devices. In some embodiments, the SWC module may use a session protocol for establishing a session over a transport layer. In some embodiments, the SWC module may uses protocols to establish a session communicated over a connection, such as a transport layer connection. In some embodiments, the SWC module may use connectionless protocol. The SWC module may use an application layer protocol to communicate data and/or transact transactions via an established session. The application layer protocol may comprise a request and response protocol or mechanisms. The protocol may carry commands and data to perform any of the desired transactions described herein. The SWC module may use any proprietary, customized or other protocol designed and constructed to perform any of the operations or transactions in here.

The SWC module may comprise an interface to a microphone of the device. The SWC module may include a listening service or receiving service to listen for audible communications or sounds via the microphone. The listening or receiver service may listen for audibles or sounds corresponding to or carrying predetermined tone, such as at a predetermined frequency. The listening or receiver service may listen for tones, audibles or sounds corresponding to or carrying predetermined encoded data, such as a request to establish a session. In some embodiments, the listening services receives encoded data via the audible communications and decodes the encoded data. The SWC module may comprise an interface to a speaker of the device. The SWC module may include a transmitter or sending service that transmits data via an encoding scheme. The transmitter or sending service may transmit the encoding data via the speaker. The transmitter or sending service may be designed and constructed to transmit a predetermined tone. The transmitter or sending service may be designed and constructed to transmit at a predetermined frequency.

In operation, the customer and merchant apps may use the SWC module(s) for sending and received data via the SWC technique. When communication between the two devices is desired, one device is placed within range of the other device. For example, a CRM customer may bring her smart phone running the SWC module within range of the merchant client which may be broadcasting a carrier tone over it's speaker. When the customer client is close enough to pickup that tone, the customer app and merchant app can handshake to establish the communication session quickly and seamlessly. At this point, the merchant device can send over the store ID and the customer application can send back the customer ID, so the merchant device knows who to credit the current transaction. Once the transaction is complete, the merchant device/app can send over the stamps earned or rewards redeemed to the customer client. The merchant can then terminate the session. The merchant device may now be ready for the next customer to handshake on the next transaction session.

The process for encoding the data to be transmitted may be very flexible depending on the amount and speed of data that needs to be transmitted. The data may be encoded using any type and form of encoding scheme. The applications using SWC can select from a plurality of encoding schemes on demand, based on policy or dynamically based on the type of data or transaction Some possible encodings are frequency modulation or amplitude modulation to encode the data to an audible frequency range that is suitable for playback and recoding on the devices' speakers and microphones. If the amount of data that needs to be transmitted is higher, more suitable complex signal encodings can be used. The transmission encoding can also be coupled with encryption to provide data security.

In many embodiments, the SWC technique converts data into sound signals in the audible range and instead of transmission over a wired network, such as a plain old telephone (POTS) line or telephone network, transmission can be carried wirelessly or in the air via devices. With smart phones and other mobile devices having speakers, microphones, as well as ample computing power, two such mobile devices may communicate directly anywhere, without needing access to the internet or radio transmitters like Bluetooth or Wifi. Although SWC is generally described herein in connection with a CRM application, SWC is not application specific. In other words, SWC can be used in many different applications outside of CRM application. For example, SWC can be used in any application in which two devices communicate and desire to communicate ad-hoc or on demand.

Some advantages of the SWC technique, include but are not limited to, not requiring internet or network access, in real time or otherwise, on both devices in order to handshake and establish the session. SWC is superior to network access based techniques because SWC can be performed locally without the help of a network, and the sound encoding is based on proven encoding technologies.

Both the customer app and merchant app may have the need to both transmit and receive to fully communicate. The SWC implementation may be the same on both clients. In some embodiments, each of the client and merchant devices may have a SWC implementation suited to or designed and constructed for their respective functionalities. When there is data that needs to be transmitted, that data is passed through an encoder or modulator to generate a sound data stream that can be played through the speaker. On the receiving end, the microphone records the transmitted sound stream and is passed through a decoder or demodulator to reconstruct the original data that was sent. There could be additional steps at either end (sender and receiver) to first encrypt the data before encoding, and similarly decrypt after decoding. The merchant app and customer application may be agnostic to the SWC technique as these apps do not need to know how the data is transmitted between devices. When an application needs to send data, the application calls the SWC module, provides the data to send, and waits for the acknowledgement of transmission was successful. Similarly on the receiving end, the application makes a call to the SWC module telling the SWC module to expect a data transmission. When the SWC module has successfully recorded, decoded and optionally decrypted the transmission, the SWC makes a callback and hands over the data received to the application.

Referring now to FIG. 4B, an embodiment of a method of using the SWC technique is depicted. In brief overview, the method, at step 450, the merchant device broadcasts a carrier tone. At step 452, the customer application is placed near the merchant device and detects the carrier tone. At step 454, the customer application responsive to the detection initiates an ad-hoc communication session. At step 456, the customer application sends customer identification information using audio-based communications of the SWC technique. At step 458, the customer application and merchant application perform a transaction using SWC.

In further details, at step 450, the merchant application may broadcast a predetermined tone via the speaker of the device. When the merchant application is in a state ready for customers, the merchant application may call the SWC module to instruct the SWC module to play or transmit a carrier signal. This signal may be similar to the sounds one hears when modems perform their handshake. The SWC module may transmit or play the carrier tone at a predetermined volume. For example, the signal may be played at a low volume, so only devices in close proximity will connect. Also the signal may be played at a low volume as not to bother the employees and customers of the store. In some embodiments, the SWC module may play the tone at a volume designed to provide a predetermined range of connectivity to the other SWC modules. The volume and range may be configurable. In some embodiments, the frequency and/or volume of the carrier tone is outside a range of human hearing.

At step 452, the SWC module of a customer application executing on a mobile device may be carried in the store or within the range of the carrier signal of the SWC module of the merchant application. The customer may place the mobile device within a predetermined distance of the device providing the carrier signal. The listening service of the SWC module may be monitoring or listening for a predetermined tone. In some embodiments, the listening service may continuously listen for a carrier tone. In some embodiments, the listening service may be enabled to listen responsive to a user request or selection of a command to enable from the interface of the customer application. In some embodiments, the listening services is automatically enabled or automatically listens responsive to checking in to the store. In some embodiments, the listening services is automatically enabled or automatically listens responsive to the automated check in features and techniques described herein. For example, when a CRM customer is about to visit a store and opens up the customer application on her smart phone. When she gets to the cashier/barista to place her order, she brings her phone next to the merchant device that is transmitting the carrier signal. The SWC module of the customer application may listen or monitor for the carrier signal/tone via the microphone of the smart phone or mobile device of the customer.

At step 454, upon the SWC module of the customer application being close enough hear the carrier signal, the SWC module can detect the carrier signal. The listening service may detect the carrier signal and inform the SWC module that another SWC module is available or in range to establish a session. Upon detection, the SWC module of the customer application can send a request to the merchant application's SWC module to establish a session via the SWC technique. The SWC modules can perform any type and form of handshake using any type and form of protocol to initiate and establish a session, such as an ad-hoc communication session. The SWC module of the customer application may send identification information of the customer and/or customer's device as part of the handshake. Likewise, the SWC module of the merchant's device may send identification information of the merchant and/or merchant's device as part of the handshake. During the handshake, the SWC modules and/or merchant and customer's device may negotiate capabilities, such as protocols, frequency and/or volume of audio for communications. The SWC modules and/or merchant and customer's device may establish a secure communication channel and exchange or identify any keys or information on the same for encrypting and decrypting data sent between devices.

At step 456, upon establishing the session, the SWC modules may communicate data and perform transactions. Via the session, the customer application and merchant application may exchange identification information. The SWC modules may inform their respective applications (customer and merchant application) that a session has been established or is available for sending/receiving data. Upon establishing the session, the customer and merchant applications can send and receive their respective merchant and customer IDs. From the customer id, the merchant device knows which customer is visiting the store. From the merchant id, the customer application can display the correct punch cards, rewards, and specials for the customer based on the merchant.

At step 458, via the session, the customer application and merchant application may perform a transaction, such as a purchase of an order of goods or services of the merchant. The customer application and merchant application via the session between the SWC modules may exchange data and perform transactions, such as data and transactions described herein. If sensitive information needs to be exchanged, such as payment information, a layer of encryption can be added to make the exchange protocol secure. The merchant's device may interface to or be integrated with any point of sale or other merchant application or device to effect or perform the transaction, such as with the assistance of personnel of the merchant.

When the customer's order transaction is complete and validated, the transaction is transmitted to the customer application so the customer application can update the display to show the punches earn on this visit, or rewards and specials redeemed at the merchant. In some embodiments, the merchant's device via the SWC session may send with the transaction, out of band from the transaction or after the transaction—any data on rewards, loyalty program, promotions, specials, advertisements, etc.

By using SWC locally to communicate between the merchant and customer application, the system is much easier to use because the need for steps 252, 258 and 262 detailed above can be eliminated. In addition, SWC also allows the system to continue to function correctly even if network connection is lost. Because SWC does not require a WAN connection, the SWC technique allows two devices to communicate when a network connection is not available. Transaction can be completed locally when either one or both devices doesn't have access to the network to reach the remote server of the CRM. Without SWC, if either device lost connection to the Internet, the customer cannot check-in and the merchant application doesn't know which customer is checked-in. So the SWC provides a redundant path for the service to function, which is increasingly more important as more and more critical services are moved to the cloud. After the network connection is restored the merchant application will send the transactions saved up to the CRM servers.

What is claimed:

1. A method of automatically checking in at a merchant location, the method comprising:
receiving, by a server, a wireless network identifier and a merchant location for a plurality of merchant locations;
storing, by the server, in a database the network identifier in association with the merchant location for each of the plurality of merchant locations;
receiving, by the server, from a client device a location of the client device;
determining, by the server, one or more merchant locations of the plurality of merchant locations that are within a predetermined distance of the location of the client device;
transmitting, by the server to the client device, the network identifiers associated with the one or more merchant locations within the predetermined distance of the location;
receiving, by the server from the client device, a notification that the client device is located at a merchant location of the one or more merchant locations associated with the network identifiers, the client device determining the merchant location responsive to a global positioning satellite (GPS) signal of the client device and a relative strength of network signals of the client device associated with the network identifiers; and
registering, by the server responsive to the notification that the client device checked in at the merchant location identified in the notification.

2. The method of claim 1, wherein the client device is one of a mobile phone, a laptop, and a tablet computer.

3. The method of claim 1, further comprising transmitting a reward or coupon to the client device.

4. A method of automatically identifying a merchant location of a client device, the method comprising:
transmitting, by an application executing on a client device, a first location of the client device to a server;
receiving, by the application, from the server a plurality of network identifiers within a predetermined distance of the first location, each of the plurality of network identifiers associated with a different merchant;
ranking, by the application, a signal strength of the client device to the plurality of network identifiers;
determining, by the application, at which merchant the client device is located based on the ranking of the signal strength of the plurality of network identifiers; and
transmitting, by the application responsive to the determination, to the server identification of the merchant.

5. The method of claim 4, further comprising automatically checking out of the location when the client device leaves the merchant by detecting when the signal strength of the network identifier of the merchant is below a predetermined signal strength and responsive to the detection, sending a notification to the server.

6. The method of claim 4, wherein the first location is determined with a GPS signal.

7. The method of claim 4, wherein the network identifiers identify WIFI networks.

8. The method of claim 4, wherein detecting the signal strength further comprises detecting the strength of a WIFI signal.

9. The method of claim 4, wherein determining at which merchant the client device is located further comprises selecting the network identifier with the highest relative signal strength.

10. The method of claim 4, further comprising re-detecting, by the application, the signal strength of at least one nearby network to determine if the client device is still within a predetermined distance of the at least one nearby network.

11. A method of conducting a transaction with an audio-based communication, the method comprising:
detecting, by a mobile device of a customer, via a microphone, a carrier tone emitted by a device of a merchant;
establishing, by the mobile device, an audio based communication session between the mobile device and the device of the merchant;
transmitting, by the mobile device to the device of the merchant, via a speaker of the mobile device, a first audio signal comprising data to conduct a transaction; and
receiving, by the mobile device, from the device of the merchant, via a microphone of the mobile device, a second audio signal comprising transaction data.

12. The method of claim 11, wherein receiving the second audio signal further comprises receiving at least one of a coupon, a transaction receipt, a check-in confirmation or a reward.

13. The method of claim 11, wherein the carrier tone comprises a predetermined frequency and volume.

14. The method of claim 11, wherein at least one of the frequency or volume of the carrier tone is outside a range of human hearing.

15. The method of claim 11, wherein transmitting the first audio signal further comprises transmitting a customer identification.

16. The method of claim 11, wherein receiving the second audio signal further comprises receiving a merchant identifier.

17. The method of claim 11, further comprising encrypting the data to conduct the transaction and decrypting the merchant transaction data.

18. The method of claim 11, further comprising placing the mobile device within a predetermined proximity of the merchant device.

19. The method of claim 18, further comprising automatically enabling the microphone responsive to detecting that the mobile device is within the predetermined proximity of the merchant device.

20. The method of claim 11, wherein receiving from the device of the merchant, the second audio signal comprising transaction data comprises data from a transaction performed by the device of the merchant for the customer.
